(19) United States
(12) Patent Application Publication
(10) Pub. No.: US 2026/0112071 A1
(43) Pub. Date: Apr. 23, 2026

(54) METHOD AND DEVICE FOR ENCODING 3D POINT CLOUD INTO BITSTREAM, AND METHOD AND DEVICE FOR DECODING 3D POINT CLOUD FROM BITSTREAM

(71) Applicant: Beijing Xiaomi Mobile Software Co., Ltd.,, Beijing (CN)

(72) Inventor: Shuo GAO, Beijing (CN)

(21) Appl. No.: 19/120,508

(22) PCT Filed: Oct. 17, 2022
(86) PCT No.: PCT/CN2022/125769

§ 371 Date: Apr. 11, 2025

(51) Int. Cl. G06T 9/40; G06T 15/08

(52) U.S. Cl. CPC G06T 9/40; G06T 15/08; G06T 2210/56

(57) ABSTRACT

A method for decoding a 3-dimensional (3D) point cloud from a bitstream is performed by a decoder. The method includes: receiving and decoding the bitstream, wherein the bitstream contains octree information including information about an octree structure of a volume of the point cloud and vertex information including information about vertex presence and a position of a vertex on edges of cuboids of leaf nodes of the octree structure; determining triangles by connecting vertices of one cuboid relating to a leaf node of the octree structure; determining points of the point cloud by voxelization of the triangles; determining whether additional information contained in the bitstream meets a pre-defined condition; and-when the pre-defined condition is met, extending at least one triangle along at least one side for voxelization based on the sampling distance.

### CROSS-REFERENCE TO RELATED APPLICATIONS

This application is the US national phase application of International Application No. PCT/CN2022/125769, filed on Oct. 17, 2022, the entire contents of which are incorporated herein by reference.

### TECHNICAL FIELD

The present disclosure relates to a method and a device for decoding a 3D point cloud from a bitstream, a method and a device for encoding a 3D point cloud into a bitstream, and a storage medium.

### BACKGROUND

Nowadays, lossless compression based on an octree representation of the geometry of the point cloud can achieve down to slightly less than a bit per point (1 bpp). This may not be sufficient for real time transmission that may involve several millions of points per frame with a frame rate as high as 50 frames per second (fps), thus leading to hundreds of megabits of data per second.

Consequently, lossy compression may be used with the usual requirement of maintaining an acceptable visual quality while compressing sufficiently to fit within the bandwidth provided by the transmission channel while maintaining real time transmission of the frames. In many applications, bitrates as low as 0.1 bpp (10× more compressed than lossless coding) would already make possible real time transmission.

However, for the lossy compression, quality of reconstruction the points of the point cloud is essential.

### SUMMARY

In a first aspect a method for decoding geometry of a 3D point cloud from a bitstream is provided. The method is implemented in a decoder, and includes:
receiving and decoding the bitstream, wherein the bitstream contains octree information including information about octree structure of a volume of the point cloud and vertex information including information about vertex presence and a position of a vertex on edges of cuboids of leaf nodes of the octree structure;
determining triangles by connecting the vertices of one cuboid relating to a leaf node of the octree structure;
determining points of the point cloud by voxelization of the triangles,
in which the method further comprising:
determining whether additional information contained in the bitstream meets a pre-defined condition, wherein the additional information is determined based on a dense degree of the point cloud, and the dense degree is evaluated by a sampling distance dₛₐₘₚₗ of the point cloud; when the pre-defined condition is met, at least one triangle is extended along at least one side for voxelization based on the sampling distance dₛₐₘₚₗ.

In another aspect of the present disclosure a method for encoding a 3D point cloud into a bitstream is provided. The method for encoding the 3D point cloud is implemented in an encoder, and includes:
obtaining octree information including an octree structure of a volume including a plurality of cuboids;
obtaining vertex information from surfaces of the point cloud for each cuboid relating to leaf node, wherein the vertex information includes information about vertex presence and position of a vertex on edges of the cuboid;
encoding the octree information and the vertex information into a bitstream;
reconstructing the point cloud geometry data by using octree information and the vertex information obtained in preceding encoding process;
wherein reconstructing the point cloud geometry data includes:
determining triangles by connecting the vertices of one cuboid relating to leaf node of the octree structure;
determining points of the point cloud by voxelization of the triangles;
in which the method further comprising:
determining additional information based on a dense degree of the point cloud, wherein the dense degree is evaluated by a sampling distance dₛₐₘₚₗ of the point cloud;
encoding the additional information into the bitstream;
determining whether the additional information meets a pre-defined condition;
when the pre-defined condition is met, at least one triangle is extended along at least one side for voxelization based on the sampling distance dₛₐₘₚₗ.

In another aspect of the present disclosure an encoder is provided. The encoder comprises a processor and a memory storing instructions executable by the processor, wherein the processor is configured to:
receive and decode a bitstream, wherein the bitstream contains octree information including information about octree structure of a volume of a 3-dimensional (3D) point cloud and vertex information including information about vertex presence and a position of a vertex on edges of cuboids of leaf nodes of the octree structure;
determine triangles by connecting the vertices of one cuboid relating to a leaf node of the octree structure;
determine points of the point cloud by voxelization of the triangles,
in which the decoder is further configured to:
determine whether additional information contained in the bitstream meets a pre-defined condition, wherein the additional information is determined based on a dense degree of the point cloud, and the dense degree is evaluated by a sampling distance of the point cloud;
when the pre-defined condition is met, at least one triangle is extended along at least one side for voxelization based on the sampling distance.

In another aspect of the present disclosure a decoder is provided. The decoder comprises a processor and a memory storing instructions executable by the processor, wherein the processor is configured to perform the method for decoding described above.

In another aspect of the present disclosure a non-transitory computer-readable storage medium is provided. The storage medium includes instructions that, when executed by a decoder, the decoder is configured to perform the method for decoding described above.

### BRIEF DESCRIPTION OF THE DRAWINGS

In the following, the present disclosure is described in more detail with reference to the accompanying figures.

FIG. 1a is a flow diagram of a method for decoding a 3D point cloud geometry according to an embodiment of the present disclosure.

FIG. 1b is a simplified flow diagram of a method for decoding according to an embodiment of the present disclosure.

FIG. 2 is a schematic diagram of a volume for generation of the octree structure.

FIG. 3 is a schematic diagram of a generated octree.

FIG. 4 shows determination of vertices on edges of a cuboid.

FIG. 5 shows generation of triangles.

FIG. 6 shows vertices on the edges of a cuboid.

FIG. 7 shows generation of the triangle by vertices.

FIG. 8 shows determination of the order of the triangles generated by vertices.

FIG. 9 is a schematic drawing for the step of voxelization.

FIG. 10 shows a triangle in a leaf node of the octree in a 2D representation.

FIG. 11 shows voxelization of the triangle in the leaf node of the octree in the 2D representation.

FIG. 12 shows barycentric coordinates for the triangle in the leaf node of the octree in the 2D representation.

FIG. 13 shows comparison between the triangle by the vertices and the original point cloud.

FIG. 14a shows the triangle in the leaf node of the octree in the 2D representation in barycentric coordinates with extension along one direction based on a fixed halo parameter.

FIG. 14b shows the triangle in the leaf node of the octree in the 2D representation in barycentric coordinates with extension along one direction based on adaptive halo parameter.

FIG. 15a shows the triangle in the leaf node of the octree in the 2D representation with extensions along all three directions based on a fixed halo parameter.

FIG. 15b shows the triangle in the leaf node of the octree in the 2D representation with extensions along all three directions based on an adaptive halo parameter.

FIG. 16 is the representation of a triangle with extensions in three directions based on the weighted halo parameter East and sampling distance of the point cloud.

FIG. 17a is the representation of a triangle with extensions in three directions based on the sampling distance of the point cloud.

FIG. 17b is the representation of a triangle with extensions in three directions according to a fixed amount.

FIG. 17c is the representation of a triangle with extensions in three directions according to a fixed amount when the sampling distance is 1.

FIG. 18 is a schematic flow diagram of a method for encoding according to an embodiment of the present disclosure.

FIG. 19a shows performance of longdress data based on different halo parameter.

FIG. 19b shows performance of house_without_roof data based on different halo parameter.

FIG. 19c shows performance of ulb_unicorn data based on different halo parameter.

### DETAILED DESCRIPTION

As a format for the representation of 3D data, point clouds have recently gained traction as they are versatile in their capability in representing all types of 3D objects or scenes. Therefore, many use cases can be addressed by point clouds, among which are
movie post-production,
real-time 3D immersive telepresence or VR/AR applications,
free viewpoint video (for instance for sports viewing),
Geographical Information Systems (aka cartography),
culture heritage (storage of scans of rare objects into a digital form),
Autonomous driving, including 3D mapping of the environment and real-time Lidar data acquisition

A point cloud is a set of points located in a 3D space, optionally with additional values attached to each of the points. These additional values are usually called point attributes. Consequently, a point cloud is combination of a geometry (the 3D position of each point) and attributes.

Attributes may be, for example, three-component colours, material properties like reflectance and/or two-component normal vectors to a surface associated with the point.

Point clouds may be captured by various types of devices like an array of cameras, depth sensors, Lidars, scanners, or may be computer-generated (in movie post-production for example). Depending on the use cases, points clouds may have from thousands to up to billions of points for cartography applications.

Raw representations of point clouds require a very high number of bits per point, with at least a dozen of bits per spatial component X, Y or Z, and optionally more bits for the attribute(s), for instance three times 10 bits for the colours. Practical deployment of point-cloud-based applications requires compression technologies that enable the storage and distribution of point clouds with reasonable storage and transmission infrastructures.

Compression may be lossy (like in video compression) for the distribution to and visual-ization by an end-user, for example on AR/VR glasses or any other 3D-capable device. Other use cases do require lossless compression, like medical applications or autonomous driving, to avoid altering the results of a decision obtained from the analysis of the compressed and transmitted point cloud.

Until recently, point cloud compression (aka PCC) was not addressed by the mass market and no standardized point cloud codec was available. In 2017, the standardization working group ISO/JCT1/SC29/WG11, also known as Moving Picture Experts Group or MPEG, has initiated work items on point cloud compression. This has led to two standards, namely
MPEG-I part 5 (ISO/IEC 23090-5) or Video-based Point Cloud Compression (V-PCC) and
MPEG-I part 9 (ISO/IEC 23090-9) or Geometry-based Point Cloud Compression (G-PCC).

Both V-PCC and G-PCC standards have finalized their first version in late 2020 and will soon be available to the market.

The V-PCC coding method compresses a point cloud by performing multiple projections of a 3D object to obtain 2D patches that are packed into an image (or a video when dealing with moving point clouds). Obtained images or videos are then compressed using already existing image/video codecs, allowing for the leverage of already deployed image and video solutions. By its very nature, V-PCC is efficient only on dense and continuous point clouds because image/video codecs are unable to compress non-smooth patches as would be obtained from the projection of, for example, Lidar-acquired sparse geometry data.

The G-PCC coding method has two schemes for the compression of the geometry.

The first scheme is based on an occupancy tree (octree/quadtree/binary tree) representation of the point cloud geometry. Occupied nodes are split down until a certain size is reached, and occupied leaf nodes provide the location of points, typically at the centre of these nodes. By using neighbour-based prediction techniques, high level of compression can be obtained for dense point clouds. Sparse point clouds are also addressed by directly coding the position of point within a node with non-minimal size, by stopping the tree construction when only isolated points are present in a node; this technique is known as Direct Coding Mode (DCM).

The second scheme is based on a predictive tree, each node representing the 3D location of one point and the relation between nodes is spatial prediction from parent to children. This method can only address sparse point clouds and offers the advantage of lower latency and simpler decoding than the occupancy tree. However, compression performance is only marginally better, and the encoding is complex, relatively to the first occupancy-based method, intensively looking for the best predictor (among a long list of potential predictors) when constructing the predictive tree.

In both schemes, attribute (de) coding is performed after complete geometry (de) coding, leading to a two-pass coding. Thus, low latency is obtained by using slices that decompose the 3D space into sub-volumes that are coded independently, without prediction between the sub-volumes. This may heavily impact the compression performance when many slices are used.

An important use case is the transmission of dynamic AR/VR point clouds. Dynamic means that the point cloud evolves with respect to time. Also, AR/VR point clouds are typically locally 2D as they most of time represent the surface of an object. As such, AR/VR point clouds are highly connected (or said to be dense) in the sense that a point is rarely isolated and, instead, has many neighbours.

Dense (or solid) point clouds represent continuous surfaces with a resolution such that volumes (small cubes called voxels) associated with points touch each other without exhibiting any visual hole in the surface.

Such point clouds are typically used in AR/VR environments and are viewed by the end user through a device like a TV, a smartphone or a headset. They are transmitted to the device or stored locally. Many AR/VR applications use moving point clouds, as opposed to static point clouds, that vary with time. Therefore, the volume of data is huge and must be compressed. Nowadays, lossless compression based on an octree representation of the geometry of the point cloud can achieve down to slightly less than a bit per point (1 bpp). This may not be sufficient for real time transmission that may involve several millions of points per frame with a frame rate as high as 50 frames per second (fps), thus leading to hundreds of megabits of data per second.

Consequently, lossy compression may be used with the usual requirement of maintaining an acceptable visual quality while compressing sufficiently to fit within the bandwidth provided by the transmission channel while maintaining real time transmission of the frames. In many applications, bitrates as low as 0.1 bpp (10× more compressed than lossless coding) would already make possible real time transmission.

The codec VPCC based on MPEG-I part 5 (ISO/IEC 23090-5) or Video-based Point Cloud Compression (V-PCC) can achieve such low bitrates by using lossy compression of video codecs that compress 2D frames obtained from the projection of the point cloud on a plane. The geometry is represented by a series of projection patches assembled into a frame, each patch being a small local depth map. However, VPCC is not versatile and is limited to a narrow type of point clouds that do not exhibit locally complex geometry (like trees, hair) because the obtained projected depth map would not be smooth enough to be efficiently compressed by a video codec.

Purely 3D compression techniques can handle any type of point clouds. It is still an open question whether 3D compression techniques can compete with VPCC (or any projection plus image coding scheme) on dense point clouds. Standardization is still under its way toward offering an extension (an amendment) of GPCC that would provide competitive lossy compression that would compress dense point clouds as good as VPCC intra while maintaining the versatility of GPCC that can handle any type of point clouds (dense, Lidar, 3D maps). This extension is likely to use the so-called TriSoup coding scheme that works over to an octree. TriSoup is under explo-ration in the standardization working group JTC1/SC29/WG7 of ISO/IEC. TriSoup encoding is also known A. DRICOT, et al, “Adaptive multi-level triangle soup for geometry—based point cloud coding”, 2019, IEEE 21st international workshop on multimedia signal processing (MMSP), Nakagami O.: “report on triangle soup decoding”, ISO/IEC JTC1/SC29-WG11 m52279, 2020, and U.S. Pat. No. 10,192,353.

However, as for all lossy compression schemes, quality of reconstruction the points of the point cloud is essential.

Thus, it is an object of the present disclosure to provide a method for decoding geometry of a 3D point cloud from a bitstream as well as encoding of a 3D point cloud into a bitstream with increased accuracy.

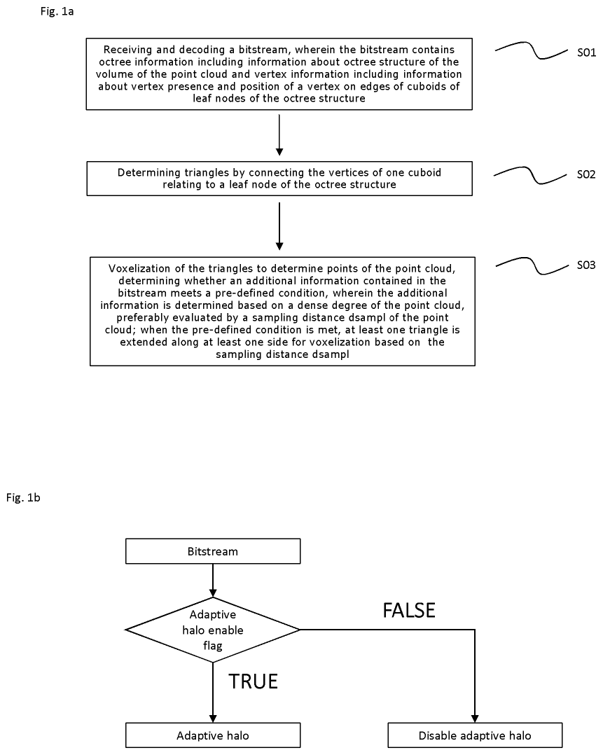

Referring to FIG. 1a showing a schematic diagram for the method of decoding geometry information of a 3D point cloud from a bitstream according to an embodiment of the present disclosure.

The method for decoding geometry of a 3D point cloud from a bitstream, implemented in a decoder, includes the steps:
In step S01 a bitstream is received and decoded, wherein the bitstream contains octree information including information about octree structure of the volume of the point cloud and vertex information including information about vertex presence and position of a vertex on edges of cuboids of leaf nodes of the octree structure;
In step S02 triangles are determined by connecting the vertices of one cuboid relating to leaf node of the octree structure;
In step S03, voxelization of the triangles is performed to determine points of the point cloud,
Whether additional information contained in the bitstream meets a pre-defined condition is determined, the additional information is determined based on dense degree of the point cloud, and the dense degree is evaluated by a sampling distance dₛₐₘₚₗ of the point cloud, when the pre-defined condition is met, at least one triangle is extended along at least one side before voxelization based on the sampling distance dₛₐₘₚₗ.

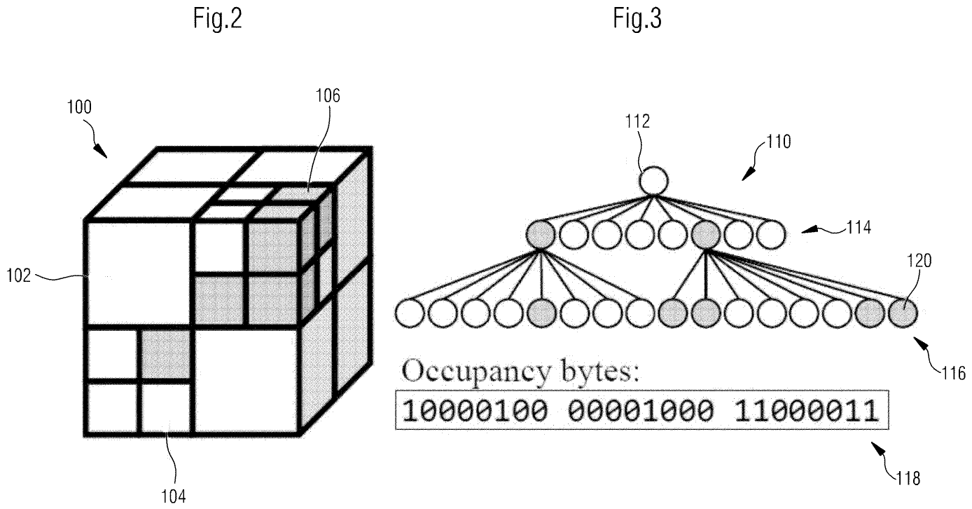

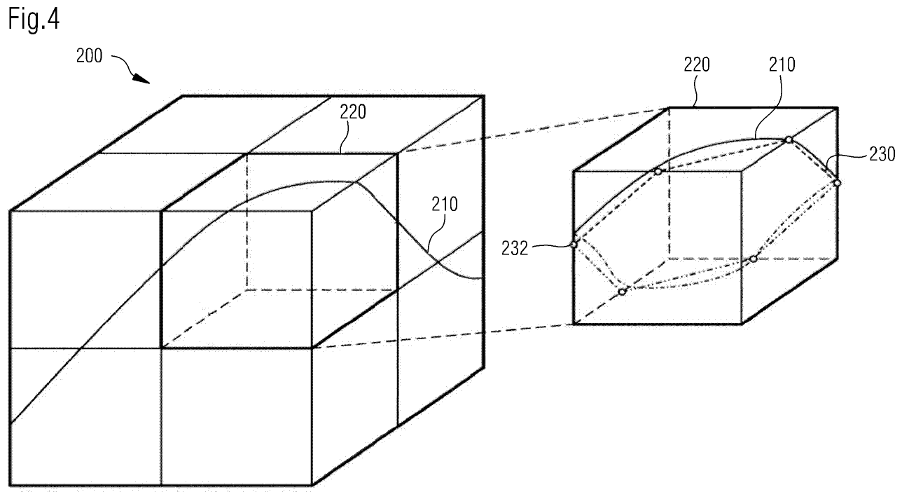

The first step of the geometry encoding process in order to determine the octree information is to build and encode an octree, as illustrated in FIGS. 2 and 3. The bounding box is the main volume 100 that contains all the points, and is associated to the root node 112 (i.e. single node at the top of the tree 110). This volume 100 is first divided into 8 sub-volumes 102 called octants, each is represented by a node 114 in the tree 110. The octants 106 that are occupied by at least one point, which are shaded in FIGS. 2 and 3, are then recursively split in sub-volumes 104 until a target level is reached.

Each octant (or node) is represented by an occupancy byte that contains one bit per child octant, set to one if it is occupied by at least one point, or to zero otherwise. The occupancy bytes 118 of all the octants are serialized (in breadth-first order) and entropy coded with a binary arithmetic encoder.

FIG. 4 illustrates a blocking representation of a 3D surface 210, as well as an example of a block 220 in a TriSoup. The surface 210 intersects the block 220, which is therefore an occupied block, and the block 220 exists among multiple blocks 200 in 3D space. Within the block 220, the enclosed portion of the surface 210 intersects the edges of the block at six illustrated vertices of a polygon 230. An edge of the block 220 is said to be selected if it contains a vertex.

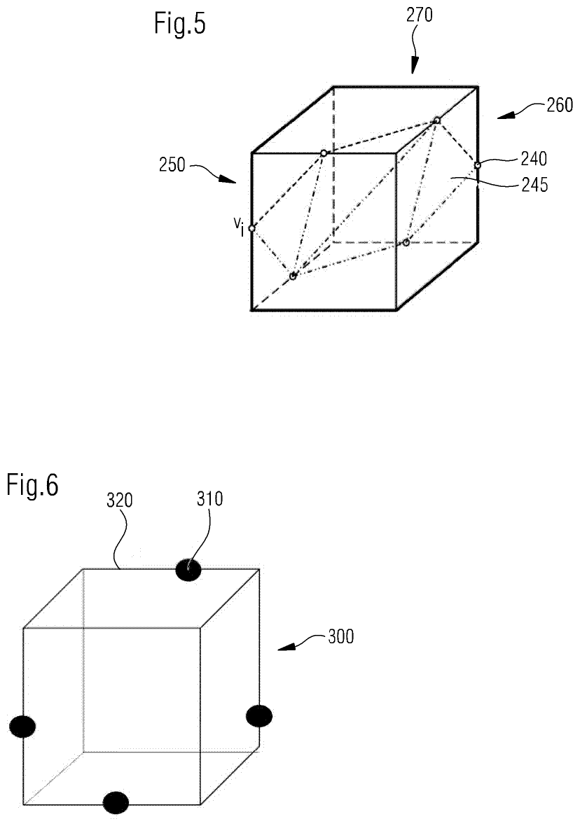

FIG. 5 illustrates the block 220 in the TriSoup, omitting the surface 210 for clarity, and showing a non-selected edge 270, a selected edge 260, and the i-th edge 250. Suppose the i-th edge 250 is selected. To specify a vertex vi on edge i, one specifies a scalar value to indicate a corresponding fraction of the length of the edge 250.

As illustrated in FIGS. 4 and 5, within each octant 220 in the target level of the octree, the trisoup represents the original surface 210 as a set of triangles 245. This surface is encoded and used to obtain the positions of the reconstructed (or decoded) points. First, the intersections of the surface represented by the original points with the edges of the octants are estimated by averaging the positions of the points that are the closest to those edges within the octant. Secondly, the twelve edges of all the octants and their associated intersections (if any) are stored as segments and vertices respectively. Each (unique) segment is then encoded as follows. A first single bit is arithmetically coded, set to one if the segment is occupied by a vertex and zero otherwise. If it is occupied, the relative position of the vertex on the segment is also arithmetically coded.

Vertices 310 of triangles are coded along the edges 320 of volumes associated with leaf nodes 300 of the tree, as depicted on FIG. 6. These vertices 310 on edge 320 are shared among leaf nodes 300 having a common edge 320. This means that at most one vertex is coded per edge belonging to at least one leaf node. By doing so, continuity of the model is ensured through leaf nodes.

As mentioned above, the encoding of the TriSoup vertices requires two information per edge:
a vertex flag indicating if a TriSoup vertex is present on the edge, and
when present, the vertex position along the edge.

Consequently, the coded data consists in the octree data plus the TriSoup data.

The vertex flag is coded by an adaptive binary arithmetic coder that uses one specific context for coding vertex flags. The position of a vertex on an edge of length N=2^{s} might be coded with unitary precision by pushing (bypassing/not entropy coding) s bits into the bitstream.

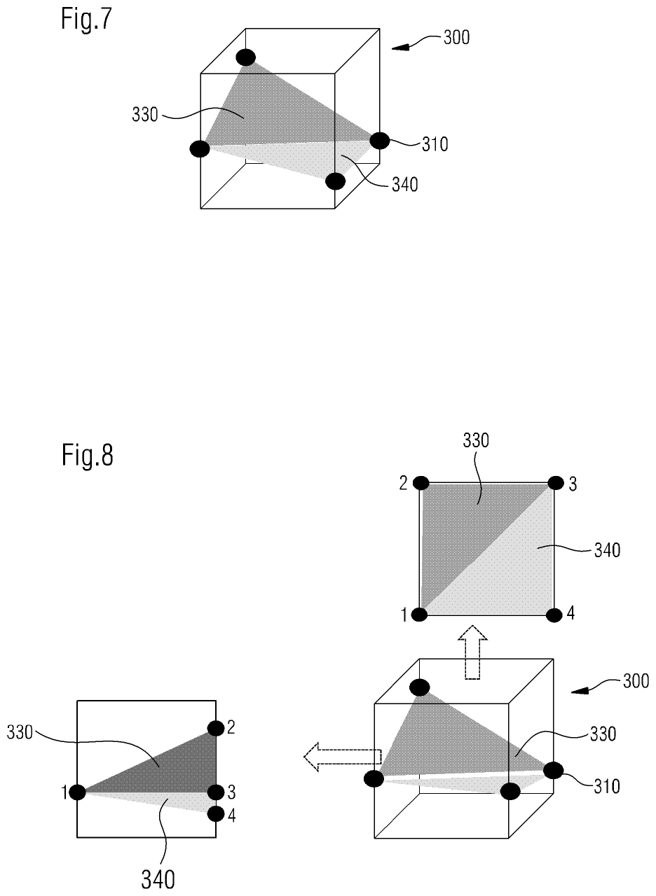

Inside a leaf node, triangles are constructed from the TriSoup vertices if at least three vertices 310 are present on the edges 320 of the leaf node 300. Reconstructed triangles 330, 340 are depicted in FIG. 7.

Obviously, other combinations of triangles 330, 340 are possible. The choice of triangles comes from a three-step process
1. determining a dominant direction along one of the three axes
2. ordering TriSoup vertices depending on the dominant direction
3. constructing triangle based on the ordered list of vertices

Knowledge about the exact position of the triangles within the current leaf is not neces-sary and can be deduced from the vertices.

FIG. 8 will be used to explain this process. Each of the three axis is tested and the one maximizing the total surfaces of triangle is kept as dominant axis. For simplicity of the figure, only the test over two axis is depicted on FIG. 8.

A first test (top) along the vertical axis is performed by projecting the cube and the Trisoup vertices 310 vertically on a 2D plane. The vertices 310 are then ordered following a clock-wise order relative to the center of the projected node (a square). Then, triangles 330, 340 are constructed following a fixed rule based on the ordered vertices. Here, triangles 123 and 134 are constructed systematically when 4 vertices are involved. When 3 vertices are present, the only possible triangle is 123. When 5 vertices are present, a fixed rule may be to construct triangles 123, 134 and 451. And so on, up to 12 vertices.

A second test (left) along a horizontal vertical axis is performed by projecting the cube and the Trisoup vertices horizontally on a 2D plane.

The vertical projection exhibits the 2D total surface of triangles that is maximum, thus the dominant axis is selected as vertical, and the constructed TriSoup triangles are obtained from the order of the vertical projection, as in FIG. 8 inside the node. It is to be noted that taking the horizontal axis as dominant would have led to another construction of triangles.

The adequate selection of the dominant axis by maximizing the projected surface leads to a continuous reconstruction of the point cloud without holes.

The rendering of TriSoup triangles into points is performed by ray tracing. The set of all rendered points by ray tracing will make the decoded point cloud.

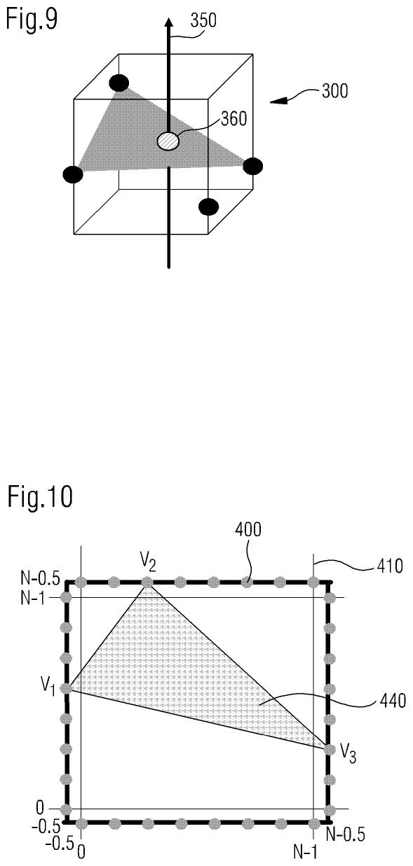

For ray tracing as shown in FIG. 9, rays are launched along the three directions parallel to an axis. Their origin is a point of integer (voxelized) coordinates of precision corresponding to the sampling precision wanted for the rendering. The intersection (if any, dashed point) with one of the Trisoup triangles is then voxelized (=rounded to the closest point at the wanted sampling precision) and added to the list of rendered points.

After applying Trisoup to all leaf nodes, i.e. constructing triangles and obtaining points by ray tracing, copies of same points in the list of all rendered points are discarded (i.e. only one voxel is kept among all voxels sharing the same position and volume) to obtain a set of decoded (unique) points.

For sake of simplicity, from here, the following FIGS. 10 to 16 will depict a 2D volume (square) instead of a 3D volume (cuboid) associated with a leaf node. The reader will keep in mind that all methods described in this invention apply to the 3D space.

Referring to FIG. 10 showing an example of a N×N×N volume with N=2^{s}=8. There are at least three vertices V₁, V₂, V₃ present on the edges 410 of the volume (depicted as a square on the figure, but actually a cuboid).

The edges of the leaf are located at positions −0.5 and N−0.5 to ensure continuity of the TriSoup model when passing from a volume to an adjacent volume. Practically, this means that faces of cuboids are shared between adjacent volumes. By doing so, the position of a vertex present on an edge does not depend on the cuboid the edge belongs to.

Positions pₖ of vertices along their respective edges are quantized positions 400 and coded into the bitstream. These positions 400 may be quantized with a unitary step such that pₖ is an integer in the interval [0, N−1]. On the example of FIG. 10, one has p₁=4, p₂=2 and p₃=2.

A TriSoup triangle 440 is constructed from the vertices V₁, V₂, V₃ and the set of triangles belonging to the volume models the point cloud encompassed by the volume.

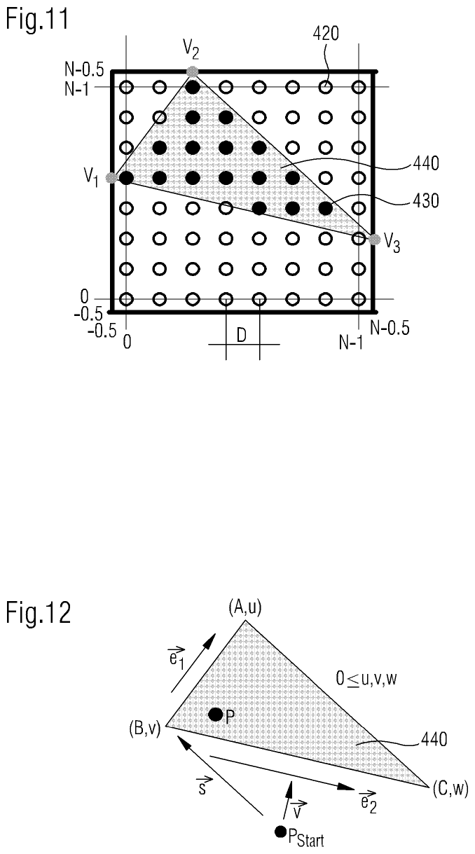

The process of recovering points 430 (of the decoded point cloud) from the triangle 440 is called voxelization of the triangles. FIG. 11 shows the voxelization of the TriSoup triangle of FIG. 10. Rays are launched along all integer coordinates 420 (white and black dots) and rays intersecting the triangle lead to a part of the decoded points (black dots). Therein the origins of the rays have a spacing D which sets the sampling resolution for the voxelization.

The intersection between a ray and a triangle is obtained by using the Möller-Trumbore algorithm that determines the position of the intersection point by using barycentric coordinates as depicted on FIG. 12.

Any point P of the 3D space can be uniquely represented by its barycentric coordinates relative to any non-degenerated 3D triangle ABC (equivalently any triangle V₁V₂V₃ from the TriSoup model).

Any point P of the 3D space can be uniquely represented as

$$P = u A + v B + w C$$

$$with the condition$$

$$u + v + w = 1.$$

Points of the triangle correspond to the convex hull. Thus,

$$0 \leq u , v , w .$$

The Möller-Trumbore determines the values of u, v; and then w is found simply by v=1−u−v. According to FIG. 12, the ray is launched from a point Pₛₜₐᵣₜ with direction v. Set the following notations for 3D vectors deduced from the 3D points as indicated in FIG. 12:

$$\vec{{e}_{1}} = \vec{BA} , \qquad \vec{{e}_{2}} = \vec{BC} \qquad and \qquad \vec{s} = \vec{{P}_{start} B} .$$

The intersection point P between the ray and the unique plane passing through A,B,C is found by the following calculation

$$\begin{matrix}\vec{h} = \vec{v} \times \vec{{e}_{2}} \\ a = \vec{{e}_{1}} \cdot \vec{h} \\ u = \vec{s} \cdot \vec{\frac{h}{a}} \\ \vec{q} = \vec{s} \times \vec{{e}_{1}} \\ w = \vec{v} \cdot \vec{\frac{q}{a}} \\ t = \vec{{e}_{2}} \cdot \vec{\frac{k}{a}} \\ P = {P}_{start} + t \vec{v}\end{matrix}$$

This intersection point P belongs to the triangle if and only if 0≤u, v, w.

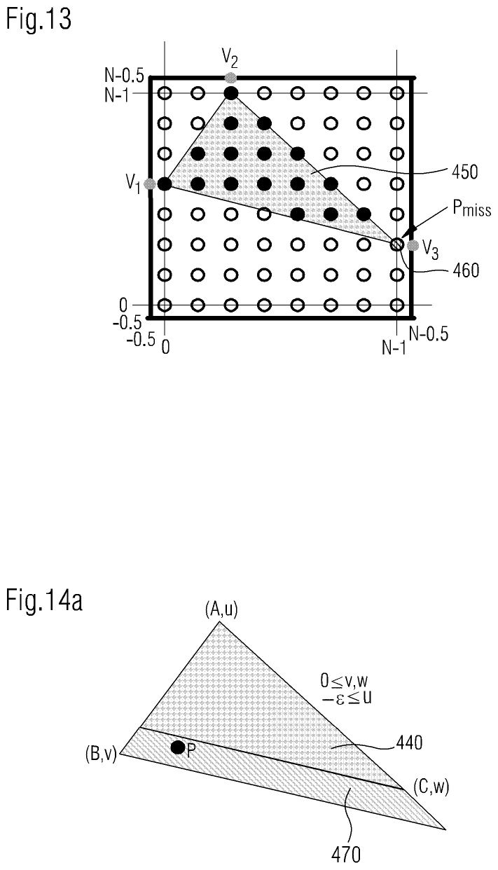

There is a slight shift between the location of the TriSoup triangle V₁V₂V₃ determined by the vertices from the bitstream and the natural position of this triangle 450 in the current volume as shown in FIG. 13. This position is natural because the encoder has deduced the location of vertices Vₖ from the closest (relative to the edge) points of the original point cloud. Therefore, it is very much likely that the voxelized points in the immediate vicinity of the vertices Vₖ are points of the point cloud. These points are natural candidates for constructing a “natural” triangle modeling the point cloud.

This shift is due to the continuity constrain through adjacent volumes. It leads to ray tracing missing some points 460 (Pₘᵢₛₛ on FIG. 13) as these points do not belong to the TriSoup triangle (compared to the triangle 440 determined by the vertices provided by the bitstream as shown in FIG. 11). A direct consequence is a drop in quantitative geometry metrics and reduced rate-distortion performance of the scheme.

Thus, a “halo” can be created around the TriSoup triangles by slightly relaxing the convex hull conditions 0≤u, v, w. By doing so, the sizes of the triangles are slightly increased such that ray tracing will intersect the increased triangles and miss less points Pₘᵢₛₛ.

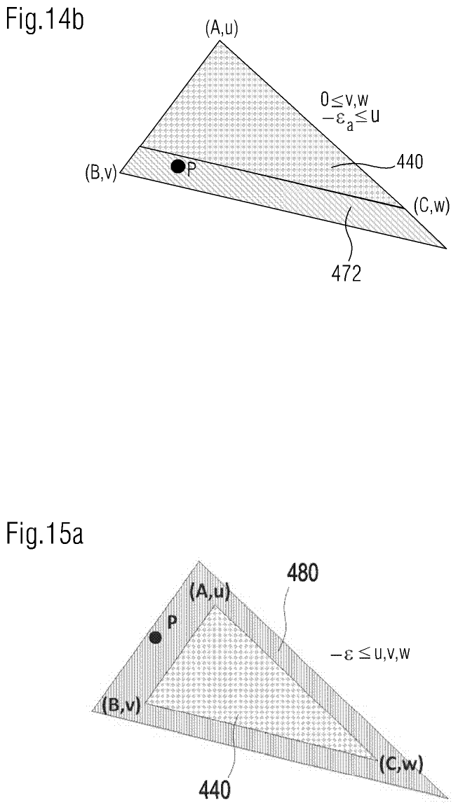

Let ε>0 be a halo parameter. As shown on FIG. 14a, relaxing the condition 0≤u into—ε≤u, where u is the barycentric weight associated with the point A, increases the triangle along the edge BC opposite to the point A indicated by the dashed area 470.

Relaxation of the conditions may be applied to the three barycentric weights u, v, and w by changing the convex hull 0≤u, v, w into

$$- ε \leq u , v , w .$$

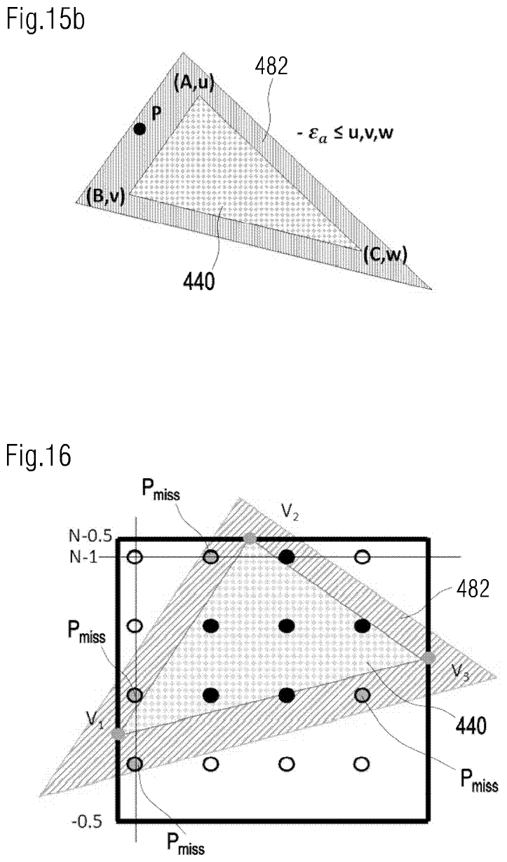

The obtained halo 480 around the triangle 440 is shown on FIG. 15a. At first order approximation, the size of the halo is proportional to the parameter ε.

The halo parameter may depend on each barycentric weight of the triangle such as

$$- {ε}_{u} \leq u , \qquad - {ε}_{v} \leq v , \qquad and \qquad - {ε}_{w} \leq w ,$$

where εᵤ, εᵥ and ε_{w} are three halo parameters.

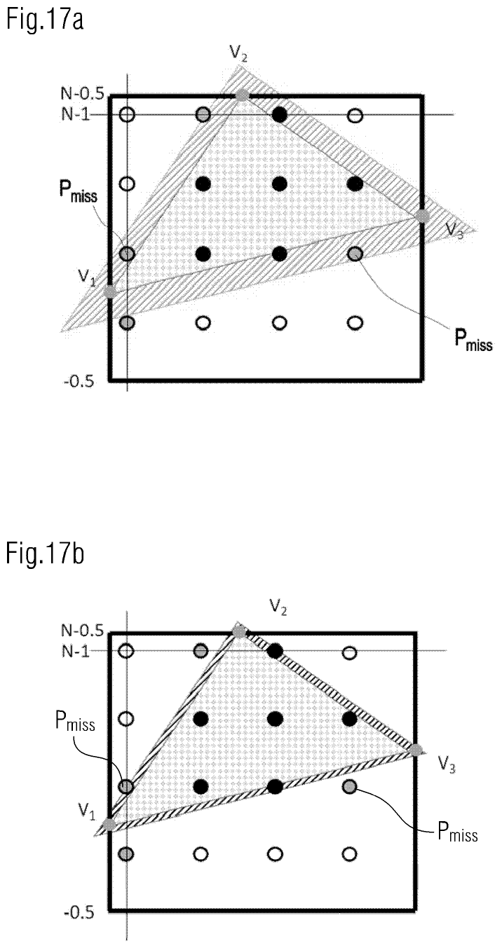

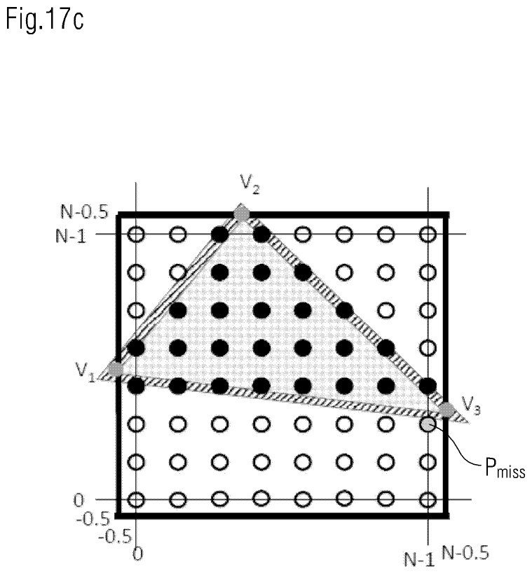

The effect on the voxelization is depicted on FIG. 17b where some of the point Pₘᵢₛₛ is now part of the “halo” and, as such, is decoded as a point of the decoded point cloud. Therefore, it is not missed as in the original algorithm.

Of course, the value of the halo parameter ε (alternatively εᵤ, εᵥ and ε_{w}) must be set such as to have an adequate size of the halo. In case ε is too small, the halo is very small and has almost no effect, thus falling back to the problem of missed points as in the prior art. In case ε is too large, the halo becomes big and the overall accuracy of the TriSoup model is impacted. In both cases, the distortion of the decoded point cloud is not optimal.

It has been observed that a reasonable value for the halo parameter ε is around ε≈¼ or ε≈⅛.

However, setting the halo parameter as a fixed value has the drawback that the created “halo” may not always get the optimal result.

To demonstrate that an arbitrary fixed halo value cannot get best result on a set data, the performance of different halo values ε on the three test point clouds named “long-dress_viewdep_vox12”, “house_without_roof_00057_vox12” and “ulb_unicorn_vox13” as used in MPEG G-PCC are tested. In the test experiment, the halo parameter value used in the G-PCC code is obtained by multiplying ε with 256 to increase the computation precision, and they are set to 16, 32, 64 and 128 such that the corresponding values of ε are 1/16, ⅛, ¼ and ½. For each data, the coding performance is obtained with these four halo values ε for the same compression rate r02.

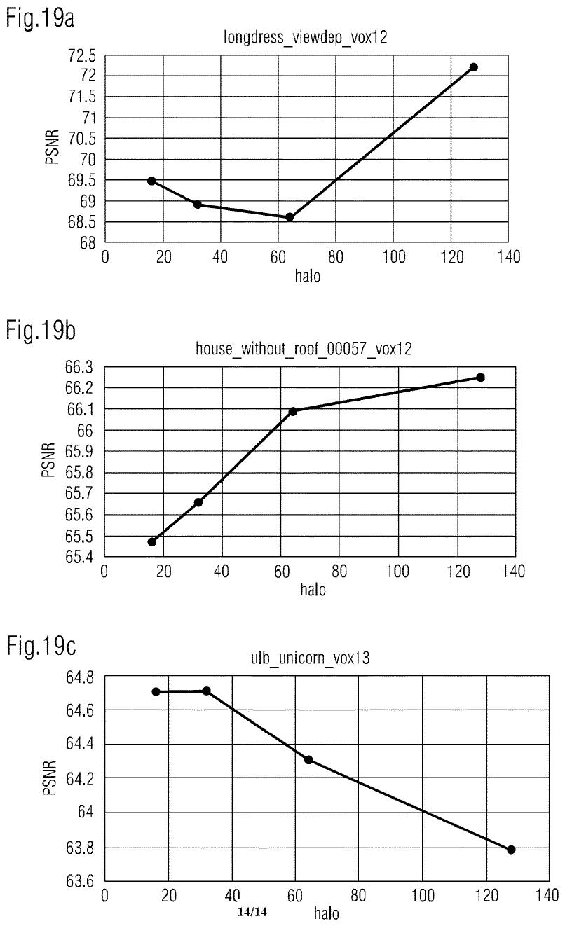

FIGS. 19a, b and c show the relationships between the quality of the decoded point cloud (geometry PSNR) and the halo ε value. Higher PSNR means better quality. It is observed that different data may achieve maximal PSNR quality at different halo values ε. For example the best halo value for longdress data is 128, the best halo value for house_without_roof data is 128 and the best halo value for ulb_unicorn data is 32. Thus, to achieve optimal compression performance on various datasets, the value of the halo parameter ε may not be fixed.

As shown in FIG. 17c, there are two natural points (represented by the full black points) close to some edges of the volume, and the TriSoup triangle V₁V₂V₃ are deduced from these points. And it is observed that there is shift between the TriSoup triangle V₁V₂V₃ and natural positions in the current volume. In FIG. 17c the sampling distance of points is 1, the enlarged triangle obtained using current fixed halo parameter ε can cover most of the natural points, except Pₘᵢₛₛ. However, if the sampling distance becomes larger, as is shown in FIG. 17b, the natural points are further from triangle compared with that when the sampling distance is 1, then using current fixed halo parameter will miss more natural points. Thus, to reduce the reconstructed error of points, a bigger halo parameter is needed for point data whose sampling distance is larger.

Thus, an adaptive “halo” is created based on the sampling distance of the point cloud around the TriSoup triangles by slightly relaxing the convex hull conditions 0≤u, v, w. By doing so, the sizes of the triangles are slightly increased such that ray tracing will intersect the increased triangles and miss less points Pₘᵢₛₛ.

The advantages of the adaptive halo method are
a lesser distortion of the decoded point cloud. Practically, quantitative metrics (BDBR) show that the proposed method according to the present disclosure can achieve 2.6% bi-trate gains (for equal quality) compared with a non-adaptive method (i.e., fixed halo parameter)
a maintained complexity because the overall algorithm is unchanged.

Let εₐ>0 be an adaptive halo parameter which is determined based on the sampling distance of the point cloud. As shown on FIG. 14b, relaxing the condition 0≤u into εₐ≤u, where u is the barycentric weight associated with the point A, increases the triangle along the edge BC opposite to the point A indicated by the dashed area 472.

Relaxation of the conditions may be applied to the three barycentric weights u, v, and w by changing the convex hull 0≤u, v, w into

$$- {ε}_{a} \leq u , v , w .$$

The obtained halo 482 around the triangle 440 is shown on FIG. 15b. At first order approximation, the size of the halo is proportional to the adaptive halo parameter εₐ. And thus, may also be proportional to the sampling distance of the point cloud.

In an embodiment, the adaptive halo parameter may additionally depend on each barycentric weight of the triangle such as

$$- {ε}_{u \_ a} \leq u , \qquad - {ε}_{v \_ a} \leq v , \qquad and \qquad - {ε}_{w \_ a} \leq w$$

where ε_{u_a}, ε_{v_a} and ε_{w_a} are three adaptive halo parameters.

The effect on the voxelization is depicted on FIG. 17a and FIG. 17b, compared with FIG. 17b, wherein there are many missing points Pₘᵢₛₛ when sampling distance becomes larger and the halo parameter keeps fixed (suitable for smaller sampling distance), in FIG. 17a several missing points Pₘᵢₛₛ are now part of the halo since the adaptive halo parameter according to the present disclosure is applied and, as such, are decoded as points of the decoded point cloud. Therefore, they are not missed as in the original algorithm.

Referring to FIG. 16, even more Pₘᵢₛₛ are now part of the halo compared with FIG. 17a. The larger halo is provided by the weighted halo parameter. Therein, the weighted parameter not only considers the sampling distance of the point could, but also associate a weight t to the sampling distance. In FIG. 16 the weight t is set to 2. Thereby, the accuracy of the decoding or reconstruction process of a 3D point cloud is further improved.

Of course, the value of the adaptive halo parameter εₐ (alternatively ε_{u_a}, ε_{v_a} and ε_{w_a}) must be set such as to have an adequate size of the halo. In case εₐ is too small, the halo is very small and has almost no effect, thus falling back to the problem of missed points as in the prior art. In case ε is too large, the halo becomes big and the overall accuracy of the TriSoup model is impacted. In both cases, the distortion of the decoded point cloud is not optimal.

It has been observed that a reasonable value for the halo parameter εₐ is around εₐ≈dₛₐₘₚₗ/4 or εₐ≈dₛₐₘₚₗ/8.

The adaptive halo parameter εₐ (alternatively ε_{u_a}, ε_{v_a} and ε_{w_a}) may be a fixed value, if the sampling distance is fixed. In a variant, the halo parameter εₐ (alternatively ε_{u_a}, ε_{v_a} and ε_{w_a}) is coded into the bitstream, for example in the Geometry Parameter Set (GPS). In another variant, the halo parameter εₐ (alternatively ε_{u_a}, ε_{v_a} and ε_{w_a}) further depends on the size N of the volume. In yet another variant, the adaptive halo parameter εₐ (alternatively ε_{u_a}, ε_{v_a} and ε_{w_a}) is signalled locally for a set of volumes representing the point cloud.

Although the adaptive halo method has many advantages, it cannot perform well on all kinds of MPEG point cloud dataset. If it is used directly in the MPEG G-PCC software, it will cause loss on overall compression results in terms of D2 (point-to-plane distortion) metric, and the overall performance gain in terms of D1 (point-to-point distortion) metric will not be very large (which is around 2%, less than 5%), so the merely implemented a single adaptive halo method cannot achieve an overall optimum performance of coding on all kinds of MPEG point cloud dataset.

In particular, in the MPEG G-PCC standard, the dataset for AR/VR can be divided into 4 categories and the 4 categories are solid, dense, sparse and scant. And solid category is voxelized point clouds with continuous surface, and dense category is voxelized point clouds that are not quite continuous, and sparse category is not dense (which is sparser than dense category), and scant category is data that is very sparse. And the adaptive halo method for trisoup model has been tested on data of all categories described above, and there are two metrics used in BDBR to eval-uate the quality of reconstructed point cloud, as described above, one is in D1 (point-to-point distortion) metric, and the other one is D2 (point-to-plane distortion) metric. The detailed experiment results on each category are:
Solid category: The adaptive halo method has no impact on compression efficiency of solid category data in terms of both D1 and D2 metrics.
Dense category: The adaptive halo method works very well on improving compression efficiency of dense category data (actually it has 5% gains) in terms of D1 metric. In terms of D2 metric, the method has very little impact on compression efficiency of dense category data.
Sparse and scant categories: the adaptive halo method can improve the compression efficiency of sparse and scant categories marginally in terms of D1 metric, but it causes loss in terms of D2 metric.

Therefore, in the last step S03 of FIG. 1a, adaptive halo method is performed selectively to achieve an overall better performance for the coding. Referring to FIG. 1b, showing a simplified flow according to the proposed method. Therein, a flag (e.g., adaptive_halo_enabled_flag) might be included in the bitstream at the encoder, the decoder might determine whether to enable the adaptive halo method according to the flag. In an implementation, the flag might be included in the Geometry Parameter Set (GPS) of the bitstream. The GPS which is described above, contains parameters specifying the features and activated tools used in the coded geometry information bitstream of a slice of point cloud, and GPS is put in the slice header of the geometry information stream. For example, if the flag is set to “true”, the adaptive halo method is enabled, otherwise the adaptive halo method is not used for the trisoup coding. If the adaptive halo method is not used, the triangles for voxelization might be extended along at least one side based on a fixed value. As described above, how the flag is set might be based on the category of the point cloud data, which can be evaluated by the sampling distance of the point cloud data. For example, if the sampling distance d of the point cloud satisfies the condition: 1<d<4 (i.e., it is dense), the value of the flag is set as true; otherwise, the value of the flag is set as false.

In some embodiments, the value (true/false) of the flag adaptive_halo_enabled_flag can be determined by reading it from the configure file for encoder of G-PCC, where the data information (including data category) are indicated in the configuration file.

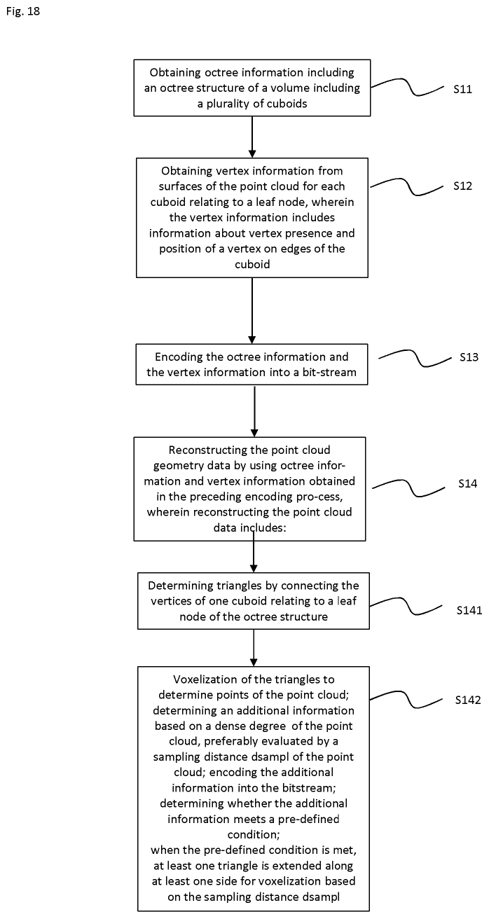

Referring to FIG. 18 showing a schematic flow diagram of the method for encoding a 3D point cloud into a bitstream according to the present disclosure. The method includes:
In step S11 octree information is determined including an octree structure of a volume including a plurality of cuboids;
In step S12, vertex information is obtained from surfaces of the point cloud for each cuboid relating to leaf node, wherein the vertex information includes information about vertex presence and position of a vertex on edges of the cuboid;
In Step S13, the octree information and the vertex information is encoded into a bitstream;
In step S14, the point cloud data is reconstructed by using octree information and vertex information obtained in the preceding encoding process, wherein reconstructing the point cloud data includes:
In step 141, triangles are determined by connecting the vertices of one cuboid relating to leaf node of the octree structure;
In step 142, voxelization of the triangles is performed to determine points of the point cloud; Additional information based on a dense degree of the point cloud (which can be evaluated by a sampling distance dₛₐₘₚₗ of the point cloud) is determined, the additional information encoded into the bitstream, whether the additional information meets a pre-defined condition is determined, when the pre-determined condition is met, at least one triangle is extended along at least one side for voxelization based on the sampling distance dₛₐₘₚₗ.

Therein steps S11 to S13 relate to the known TriSoup encoding which is known for example from A. DRICOT, et al, “Adaptive multi-level triangle soup for geometry—based point cloud coding”, 2019, IEEE 21st international workshop on multimedia signal processing (MMSP), Nakagami O.: “report on triangle soup decoding”, ISO/IEC JTC1/SC29-WG11 m52279, 2020, and U.S. Pat. No. 10,192,353. In addition the usual encoding of the point cloud, the method includes a reconstruction step which includes the same or similar steps as that in the decoding method described before in particular with reference to FIG. 1. The reconstructed point cloud can then be used to interpolate attributes (like colours) and then encode attributes of the points of the point cloud based on reconstructed geometry.

The present disclosure provides a method for decoding, a method for encoding, an encoder, a decoder, a bitstream and a software.

In a first aspect a method for decoding geometry of a 3D point cloud from a bitstream is provided. The method is implemented in a decoder, and the method includes:
receiving and decoding a bitstream, wherein the bitstream contains octree information including information about octree structure of the volume of the point cloud and vertex information including information about vertex presence and position of a vertex on edges of cuboids of leaf nodes of the octree structure;
determining triangles by connecting the vertices of one cuboid relating to a leaf node of the octree structure;
determining points of the point cloud by voxelization of the triangles, in which the method further comprising:
determining whether additional information contained in the bitstream meets a pre-defined condition, wherein the additional information is determined based on a dense degree of the point cloud, and the dense degree is evaluated by a sampling distance dₛₐₘₚₗ of the point cloud;
when the pre-defined condition is met, at least one triangle is extended along at least one side for voxelization based on the sampling distance dₛₐₘₚₗ.

Thus, in a first step a bitstream is received and the bitstream contains information regarding the octree structure of the volume of the point cloud which are decoded. In an implementation, the geometry of the Point cloud is GPCC-encoded. Thus, by decoding from the bitstream the octree information about the volume of the point could is provided. Further, the bitstream also includes vertex information including information about vertex presence and position of a vertex on edges of the cuboids relating to leaf nodes in the octree structure. Thus, the vertex information is provided by decoding from the bitstream. In an implementation, the bitstream is encoded by a TriSoup encoding scheme at the encoder.

After decoding the octree information and vertex information from the bitstream which is described in previous one step, in a further step, for reconstructing the point cloud geometry, triangles are determined for each cuboid by connecting vertices on the edges of the cuboids. Thus, the surfaces of the triangles are determined by the position of the vertices included in the bitstream. In order to reconstruct the points of the point cloud from the triangles, voxelization is performed by a ray-tracing process wherein in the ray-tracing process rays are launched along the three directions parallel to any of the three axes. Their origin is a point of integer coordinates corresponding to the sampling precision wanted for the rendering. The intersection point (if any) of the ray with one of the triangles is then determined and added to the list of rendered points, i. e. added to the points of the point cloud. The surface of the triangles is sampled by the rays during voxelization in order to determine the points of point cloud.

Therein, according to the present disclosure, how the triangles are determined is based on additional information contained in the bitstream, there are different schemes for determining triangles:

Scheme 1. Adaptive halo: Therein at least one triangle is extended along at least one side for/during voxelization to extend the surface of the triangle along at least one direction based on a sampling distance dₛₐₘₚₗ of the point cloud. Therein, the sampling distance is a property of the initial point cloud data and relates to the distance between the actual sampling points of the point cloud in units of the sampling resolution if there is no missing points during data acquiring. Therein, dₛₐₘₚₗ is set by for example the device acquiring the point of the point cloud, such as a LIDAR or the like. Thus, by the extension of the triangle in the voxelization process, the accuracy of the voxelization process can be enhanced, since additional points of the original point cloud can be reliably determined which would otherwise be neglected during the voxelization process. Since the triangles are sampled with a certain precision and sampling resolution, points of the point cloud which are just outside the triangle are now captured due to extending the triangle along at least one side in order to enlarge the surface of the triangle. Moreover, since the extension of the triangle is based on the sampling distance of the point cloud, the extension will be adaptive to any point cloud whatever the sampling distance is. In an implementation, the extension is proportional to the sampling distance of the point cloud. Thus, if the sampling distance of the point cloud becomes larger, the triangle will also be extended to a larger degree. Further details of the adaptive halo scheme are described in the dependent claims. Hence, in many cases higher accuracy for reconstructing the 3D point cloud is achieved and the number of sampling errors in the process of voxelization is reduced. In addition, the complexity of the encoding and/or decoding algorithm is maintained. However, this scheme cannot perform well on all kinds of point clouds. In some cases, it might even cause loss on the compression result.

Scheme 2. halo with a fixed value or others: comparing to the adaptive halo, the extension of the triangles in this scheme is based on a fixed value which is not relevant to the sampling distance of the point cloud. It will be understood that scheme 2 might also be other schemes for determining triangles, for example, do not extend the triangles at all.

Therefore, according to the present disclosure, the additional information contained in the bitstream is used for the selection of adaptive halo or non-adaptive halo scheme. By introducing such an indicator, each scheme according to the present disclosure can be applied to an appropriate use case such that an overall better compression performance can be achieved compared to the solutions which only a single scheme is implemented.

In an embodiment, at least one triangle is extended at more than one side in order to further enlarge the surface of the respective triangle. Thus, the triangle can be enlarged at one side, two sides or all three sides in order to include points of the original point cloud which are just beyond the triangle determined by the vertices on the edges of the cuboids.

In an embodiment, if one cuboid of a leaf node of the octree structure may contain more than one triangle, each triangle in the cuboid is extended along at least one side for voxelization. Thus, extension of the surface of the triangle may be applied to all triangles in a cuboid. Alternatively or additionally, in each cuboid of the octree structure the at least one triangle is extended along at least one side for voxelization. Alternatively, extension of the one or more sides of triangles will be applied only to a subset of leaf nodes in the octree structure. Therein, the subset can be determined for example by the application, the density of the points in leaf nodes of the point cloud or the requirements on accuracy vs. decoding speed. In an implementation, the one or more sides of the triangles is extended based on the local sampling distance. Thus, triangles of each subset of leaf nodes may be extended in a way the local optimum performance can be reached.

In an embodiment, the extension is the same for each side. Thus, a triangle is extended for the same amount along at least two directions in order to enlarge the surface of the triangle. In an implementation, the amount of extension is the same for all three directions. Alternatively, at least along two directions the extension is different. Thus, different directions can be handled dif-ferently in order to enhance accuracy of the decoding.

In an embodiment, the extensions are the same for each leaf node of the octree structure or are different. If there are different extensions for more than one or each side of a triangle in one leaf node of the octree structure, then this can be the same in other leaf nodes of the octree structure or can be different. Therein, the extension can be pre-selected or can be determined for example by the application, the density of the points in leaf nodes of the point cloud or the requirements on accuracy vs. decoding speed.

In an embodiment, voxelization is performed by the Möller-Trumbore algorithm.

In an embodiment, in the Möller-Trumbore algorithm the convex hull requirement is re-laxed to −εₐ≤u, v, w with εₐ>0 and u, v, w the barycentric coordinates of the triangle wherein εₐ is determined based on the sampling distance dₛₐₘₚₗ of the point cloud. In the original Möller-Trumbore algorithm the convex hull requirement is set to be 0≤u, v, w. Thus, by relaxing this requirement to be −εₐ≤u, v, w, the surface of the considered triangle is enlarged and voxelization of points of the original point cloud which would otherwise not be considered in the reconstructed point cloud during the sampling will now be included. In particular, since εₐ is determined based on the sampling distance dₛₐₘₚₗ of the point cloud, the extension will be adaptive to any point cloud whatever the sampling distance is. In an embodiment, the extension is proportional to the sampling distance of the point cloud. Thus, if the sampling distance of the point cloud becomes large, the triangle will also be extended to a larger degree. Thereby quality of reconstruction and appearance of the final reconstructed point cloud is enhanced.

In an embodiment, the convex hull requirement is set to be −ε_{u_a}≤u, −ε_{v_a}≤v and −ε_{w_a}≤w with ε_{u_a}, ε_{v_a}, ε_{w_a}≥0 and u, v, w the barycentric coordinates of the triangle, wherein at least one of ε_{u_a}, ε_{v_a}, ε_{w_a} is determined based on the sampling distance dₛₐₘₚₗ of the point cloud. Thus for the different direction, an individual convex hull requirement can be provided to individually control the extension of the triangle under consideration. Therein ε_{u_a}≠ε_{w_a}. Alternatively or additionally is ε_{u_a}≠ε_{v_a}. Alternatively or additionally is ε_{v_a}≠ε_{w_a}. Thus, the extension in one or more direction can be selected independently from the other directions to individually determine the extension.

In an embodiment, the extension is provided by an adaptive halo parameter. Therein in the case of the Möller-Trumbore algorithm the adaptive halo parameter is provided by εₐ and for the different directions by ε_{u_a}, ε_{v_a} and ε_{w_a}. Thus, by the adaptive halo parameter the amount of extension is determined and can be quantified based on the sampling distance of the point cloud.

In an embodiment, the adaptive halo parameter is set to be the less than ¼ dₛₐₘₚₗ. In an implementation, the adaptive halo parameter is set to be less than ⅛ dₛₐₘₚₗ. Thus, by selection of the adaptive halo parameter amount of the extension can be tailored to achieve the best result, wherein larger values will result in more points determined in the voxelization process. A preferred range of the adaptive halo parameter would be between 0 and dₛₐₘₚₗ. If the sampling distance is large, the adaptive halo parameter also becomes large thereby increasing the amount of the extension. Thus, even if the sampling distance varies, the present disclosure provides an adaptive solution to extend the triangle so that it could be guaranteed that there are always a reasonable number of points covered by the extended triangle.

In an embodiment, the adaptive halo parameter is set in advance. Thus, the encoder and the decoder might have agreed on the adaptive halo parameter and thus the adaptive halo parameter is fixed for every point cloud generated by the encoder and reconstructed by the decoder. The information about the adaptive halo parameter need not to be encoded into the bitstream.

Alternatively, the adaptive halo parameter is encoded into the bitstream and, in an implementation, in the geometry parameter set (GPS) of the bitstream. This can be done once in the case where the adaptive halo parameter is set for every subsequent point cloud to be decoded. Alternatively for each point cloud individually a respective adaptive halo parameter or a set of adaptive halo parameters can be encoded.

Alternatively, the adaptive halo parameter further depends on the size of the volume of the cuboid, i.e. the level of the octree of the current leaf node.

In an embodiment, the sampling distance dₛₐₘₚₗ of the point cloud is determined by

$${d}_{sampl} = \sqrt{\frac{{N}_{leaf}}{{N}_{total}}} \cdot N ,$$

with N_{leaf} being the number of the leaf node, Nₜₒₜₐₗ being the number of points in the point cloud and N the size of the respective cuboid of the leaf node or the sampling distance dₛₐₘₚₗ of the point cloud is determined by a looping method. Therein, at the encoder side Nₜₒₜₐₗ in known to the encoder. Also, the number N_{leaf} of leaf nodes is known at the encoder side. Further, N defines the size of the leaf node in the unit of sampling resolution of original point cloud data acquired by devices. Hence, dₛₐₘₚₗ can be determined from the point cloud data before the voxelization and is dependent on the size of the cuboids of the leaf nodes. Hence, with increasing size N of the leaf nodes, also dₛₐₘₚₗ increases thereby increasing the adaptive halo parameter. Additionally or alternatively, the sampling distance may also be determined by looping method to select a best sampling distance during the vocalization process. In detail, the looping method tries different integer value for estimating sampling distance by starting from 1 to N, and it increases the sampling distance by 1 from this loop to go to next loop. In each loop k, it estimates the point number of reconstructed point cloud generated during voxelization process by using the sampling distance dk for this loop and compare the point number with Nₜₒₜₐₗ of original point cloud; and if the point number of reconstructed point cloud are larger than Nₜₒₜₐₗ at i-th loop, then the loop method ends, and the estimated sampling distance used for voxelization is equal to dᵢ−1.

In an embodiment, the at least one triangle is extended along at least one side for voxelization based on a weighted halo parameter ε_{a_t}, wherein the weighted halo parameter ε_{a_t} is determined by ε_{a_t}=εₐ*t, with εₐ being an adaptive halo parameter based on the sampling distance dₛₐₘₚₗ of the point cloud and providing extension of the at least one triangle, t being a corresponding weight associated with the sampling distance. In an implementation, t is set to 2. In some embodiments t is selected to be between 1 and 4. In an implementation, t is selected to be between 1.5 and 2.5. Therein, a heuristic method might be used to determine the value of t. Heuristic method is an optimization approach that tries to discover the global optimal feasible solution for a specific problem being considered. The heuristic method is iterative in nature. After each iteration, a feasible solution to the specific problem is identified. When the heuristic method is terminated after an amount of time or a number of iterations, the output solution is the best solution found in any iteration. In an implementation, the weight to be tried in each iteration is an integer selected from a range of 1 to 4. Therein, the adaptive halo parameter is less than 1. If the weight is too large, the overall accuracy of the TriSoup model might be impacted. Thus, an upper limit might be set to 4. For example, if the adaptive halo parameter is ¼ and it is determined that a best result can be achieved by assigning a weight 2 to the sampling distance. The updated adaptive halo parameter might be ¼*2=½ if the adaptive halo parameter is proportional to the sampling distance. Therefore, by providing a proper range for setting the weight, the efficiency and accuracy of the overall algorithm could be further improved. It will be understood that a different weight may also be separately determined in different directions of the triangle.

In an embodiment, the additional information is a flag, for example one bit, for enabling or disabling a function of the encoding or decoding method. In the simplest case, the additional information might be a one-bit flag indicating whether the adaptive halo scheme shall be enabled. It will be understood that the additional information might also be multiple bits as long as it is capable of indicating the required information according to the present disclosure.

In an embodiment, the additional information is encoded into the Geometry Parameter Set (GPS) of the bitstream.

In another aspect of the present disclosure a method for encoding a 3D point cloud into a bitstream is provided. The method for encoding the 3D point cloud is implemented in an encoder and includes:
obtaining octree information including an octree structure of a volume including a plurality of cuboids;
obtaining vertex information from surfaces of the point cloud for each cuboid relating to leaf node, wherein the vertex information includes information about vertex presence and position of a vertex on edges of the cuboid;
encoding the octree information and the vertex information into a bitstream;
reconstructing the point cloud geometry data by using octree information and the vertex information obtained in preceding encoding process;
wherein reconstructing the point cloud geometry data includes:
determining triangles by connecting the vertices of one cuboid relating to leaf node of the octree structure;
determining points of the point cloud by voxelization of the triangles;
in which the method further comprising:
determining additional information based on a dense degree of the point cloud, wherein the dense degree is evaluated by a sampling distance dₛₐₘₚₗ of the point cloud;
encoding the additional information into the bitstream;
determining whether the additional information meets a pre-defined condition;
when the pre-defined condition is met, at least one triangle is extended along at least one side for voxelization based on the sampling distance dₛₐₘₚₗ.

Thus, by the method for encoding, the octree information as well as the vertex information are generated. In addition, additional information is determined and generated based on dense degree of the point cloud, for example according to the sampling distance of the point cloud. It will be understood that the dense degree might also be determined by other methods which will not be detailed here. This information is encoded into the bitstream. Subsequently at the encoder side, a reconstruction step is performed. In this reconstruction step the point cloud geometry information is reconstructed, wherein the steps of reconstructing are the same as that in the method for decoding as described above. The reconstructed geometry of point cloud at the encoder side is then used to encode attributes (color, reflectance, . . . ) of the points of the point cloud for example by RAHT (Region-Adaptive Hierarchical Transform), predicting transform or lifting transform being used in order to encode the attributes of the points of the point cloud.

In an embodiment, geometry of the point cloud is encoded into the bitstream by Geometry-based Point Cloud Compression (G-PCC).

In an embodiment, the bitstream is an MPEG G-PCC compliant bitstream.

In an embodiment, the method for encoding is further built according to the features described before in connection with the method for decoding.

In another aspect of the present disclosure an encoder is provided for encoding a 3D point cloud into a bitstream. The encoder comprises a memory and a processor, wherein instructions are stored in the memory, which when executed by the processor perform the steps of the method for encoding described before.

In another aspect of the present disclosure a decoder is provided for decoding a 3D point cloud from a bitstream. The decoder comprises a memory and a processor, wherein instructions are stored in the memory, which when executed by the processor perform the steps of the method for decoding described before.

In another aspect of the present disclosure a bitstream is provided, wherein the bitstream is encoded by the steps of the method for encoding described before.

In another aspect of the present disclosure a computer-readable storage medium is provided comprising instructions to perform the steps of the method for encoding a 3D point cloud into a bitstream as described above.

In another aspect of the present disclosure a computer-readable storage medium is provided comprising instructions to perform the steps of the method for decoding a 3D point cloud from a bitstream as described above.

In another aspect of the present disclosure a computer-readable storage medium is provided comprising instructions to perform the steps of the method for encoding a 3D point cloud into a bitstream as described above and further comprising a configure file indicating a type of the point cloud, which indicates the dense degree of a point cloud. Therein, the type of the point cloud might be for example, solid, dense, sparse and scant. However, it will be understood that such types in essence can be distinguished by the sampling distance of the point cloud as described above. In any of the embodiments described above, the additional information might also be determined based on such type of the point cloud (e.g., by obtaining information from the configure file).

1. A method for decoding a 3-dimensional (3D) point cloud from a bitstream, performed by a decoder, comprising:
receiving and decoding the bitstream, wherein the bitstream contains octree information including information about an octree structure of a volume of the point cloud and vertex information including information about vertex presence and a position of a vertex on edges of cuboids of leaf nodes of the octree structure;
determining triangles by connecting vertices of one cuboid relating to a leaf node of the octree structure;
determining points of the point cloud by voxelization of the triangles;
determining whether additional information contained in the bitstream meets a pre-defined condition, wherein the additional information is determined based on a dense degree of the point cloud, and the dense degree is evaluated by a sampling distance of the point cloud; and
when the pre-defined condition is met, extending at least one triangle along at least one side for voxelization based on the sampling distance.

2. (canceled)

3. (canceled)

4. The method according to claim 1, wherein the at least one triangle is extended at two or three sides for voxelization;
wherein each triangle in a cuboid, and at least one triangle in each cuboid of the point cloud having a triangle is extended, and the extension is the same for each side or different for at least two sides.

5. (canceled)

6. (canceled)

7. The method according to claim 1, wherein a Möller-Trumbore algorithm is used for voxelization, or voxelization of a point is obtained by rounding its coordinates to nearest integers.

8. The method according to claim 7, wherein a convex hull requirement is −εₐ≤u, v, w, with εₐ>0 and u, v, w being barycentric coordinates of the triangle, wherein εₐ is determined based on the sampling distance of the point cloud; or
the convex hull requirement is −_{u_a}≤u, −ε_{v_a}≤v and −ε_{w_a}≤w, with ε_{u_a}, ε_{v_a}, ε_{w_a}>0 and u, v, w being the barycentric coordinates of the triangle and at least one of ε_{u_a}≠ε_{w_a}, ε_{u_a}≠ε_{v_a}, or ε_{v_a}≠ε_{w_a} exists, wherein at least one of ε_{u_a}, ε_{v_a}, ε_{w_a} is determined based on the sampling distance of the point cloud.

9. (canceled)

10. The method according to claim 1, wherein the extension is provided by one of:
a halo parameter less than one quarter of the sampling distance;
an adaptive halo parameter, wherein the extension is set in advance; or
an adaptive halo parameter encoded in the bitstream.

11. (canceled)

12. (canceled)

13. The method according to claim 1, wherein the sampling distance of the point cloud is determined by
$${d}_{sampl} = \sqrt{\frac{{N}_{leaf}}{{N}_{total}}} .$$
with dₛₐₘₚₗ being the sampling distance, N_{leaf} being a number of the leaf nodes, Nₜₒₜₐₗ being a number of points in the point cloud, and N being a size of the respective cuboid of the leaf node; or
the sampling distance of the point cloud is determined by a looping method.

14. The method according to claim 1, wherein the at least one triangle is extended along at least one side for voxelization based on a weighted halo parameter, wherein the weighted halo parameter is determined by εₐₜ=εₐ*t, with ε_{a_t} being the weighted halo parameter, εₐ being an adaptive halo parameter based on the sampling distance of the point cloud and providing extension of the at least one triangle, t being a corresponding weight associated with the sampling distance, and 1<t<4.

15. The method according to claim 1, wherein the additional information is a flag for enabling or disabling a function of the method.

16. (canceled)

17. A decoder, comprising:
a processor; and
a memory storing instructions executable by the processor,
wherein the processor is configured to:
receive and decode a bitstream, wherein the bitstream contains octree information including information about an octree structure of a volume of a 3-dimensional (3D) point cloud and vertex information including information about vertex presence and a position of a vertex on edges of cuboids of leaf nodes of the octree structure;
determine triangles by connecting the vertices of one cuboid relating to a leaf node of the octree structure;
determine points of the point cloud by voxelization of the triangles,
determine whether additional information contained in the bitstream meets a pre-defined condition, wherein the additional information is determined based on a dense degree of the point cloud, and the dense degree is evaluated by based on a sampling distance of the point cloud; and
when the pre-defined condition is met, extend at least one triangle along at least one side for voxelization based on the sampling distance.

18. (canceled)

19. A non-transitory computer-readable storage medium storing instructions that, when executed by a processor, cause the processor to perform the method according to claim 1.

20. A method for encoding a 3-dimensional (3D) point cloud into a bitstream, performed by an encoder, comprising:
obtaining octree information including an octree structure of a volume including a plurality of cuboids;
obtaining vertex information from surfaces of the point cloud for each cuboid relating to a leaf node, wherein the vertex information includes information about vertex presence and a position of a vertex on edges of the cuboid;
encoding the octree information and the vertex information into the bitstream;
reconstructing point cloud geometry data by using the octree information and the vertex information, wherein reconstructing the point cloud geometry data includes:
determining triangles by connecting the vertices of one cuboid relating to a leaf node of the octree structure;
determining points of the point cloud by voxelization of the triangles;
determining additional information based on a sampling distance of the point cloud;
encoding the additional information into the bitstream;
determining whether the additional information meets a pre-defined condition; and
when the pre-defined condition is met, extending at least one triangle along at least one side for voxelization based on the sampling distance.

21. The method according to claim 20, wherein the encoding is a Trisoup encoding.

22. The method according to claim 20, wherein the at least one triangle is extended at two or three sides for voxelization,
wherein each triangle in a cuboid, and at least one triangle in each cuboid of the point cloud having a triangle is extended, wherein the extension is the same for each side or different for at least two sides.

23. The method according to claim 20, wherein a Möller-Trumbore algorithm is used for voxelization, or voxelization of a point is obtained by rounding its coordinates to nearest integers.

24. The method according to claim 23, wherein a convex hull requirement is −εₐ≤u, v, w, with εₐ>0 and u, v, w being barycentric coordinates of the triangle, wherein εₐ is determined based on the sampling distance of the point cloud; or
the convex hull requirement is −ε_{u_a}≤u, −εv_a≤v and −ε_{w_a}≤w, with ε_{u_a}, ε_{v_a}, ε_{w_a}>0 and u, v, w being the barycentric coordinates of the triangle and at least one of ε_{u_a}≠ε_{w_a}, ε_{u_a}≠ε_{v_a}, or ε_{v_a}≠ε_{w_a} exists, wherein at least one of ε_{u_a}, ε_{v_a}, ε_{w_a} is determined based on the sampling distance of the point cloud.

25. The method according to claim 20, wherein the extension is provided by one of:
a halo parameter less than one quarter of the sampling distance;
an adaptive halo parameter, wherein the extension is set in advance; or
an adaptive halo parameter encoded in the bitstream.

26. The method according to claim 20, wherein the sampling distance of the point cloud is determined by
$${d}_{sampl} = \sqrt{\frac{{N}_{leaf}}{{N}_{total}}} \cdot N ,$$
with dₛₐₘₚₗ being the sampling distance, N_{leaf} being a number of the leaf nodes, Nₜₒₜₐₗ being a number of points in the point cloud and N being a size of the respective cuboid of the leaf node, or
the sampling distance of the point cloud is determined by a looping method.

27. The method according to claim 20, wherein the at least one triangle is extended along at least one side for voxelization based on a weighted halo parameter, wherein the weighted halo parameter is determined by ε_{a_t}=ₐ*t, with ε_{a_t} being the weighted halo parameter, εₐ being an adaptive halo parameter based on the sampling distance of the point cloud and providing extension of the at least one triangle, t being a corresponding weight associated with the sampling distance, and 1<t<4.

28. The method according to claim 20, wherein the additional information is a flag for enabling or disabling a function of the method.

29. An encoder, comprising:
a processor; and
a memory storing instructions executable by the processor,
wherein the processor is configured to perform the method according to claim 20.
